(19) United States
(12) Patent Application Publication
(10) Pub. No.: US 2006/0046656 A1
(43) Pub. Date: Mar. 2, 2006

(54) BLUETOOTH HEADSET AND BLUETOOTH DEVICE CONNECTABLE TO AUDIO EQUIPMENT

(76) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,932

(22) Filed: Oct. 13, 2004

(30) Foreign Application Priority Data
Aug. 30, 2004 (TW) 93125997

(51) Int. Cl. H04Q 7/20

(52) U.S. Cl. 455/41.3; 455/41.2

(57) ABSTRACT

A bluetooth headset and a bluetooth device connectable to audio equipment are provided. The bluetooth device is suitable for connecting a stereo headset. The bluetooth headset and the bluetooth device are suitable for transceiving signals in a mobile communication device and an audio equipment. Both the bluetooth headset and the bluetooth device at least comprise a bluetooth transceiver and an audio-in port. The bluetooth transceiver is used to transceive signals from the mobile communication device. The audio-in port connects the audio equipment. Wherein, when a calling signal from the mobile communication device is received by the bluetooth transceiver, the audio signal transmitted to the stereo headset connected to the bluetooth device is switched to the audio signal provided by the mobile communication device, and the audio signal transmitted to a speaker of the bluetooth headset is switched to the audio signal provided by the mobile communication device.

### CROSS-REFERENCE TO RELATED APPLICATION

This application claims the priority benefit of Taiwan application serial no. 93125997, filed Aug. 30, 2004.

### BACKGROUND OF THE INVENTION

1. Field of the Invention

The present invention relates to a bluetooth headset and a bluetooth device, and more particularly, to a bluetooth headset and a bluetooth device connectable to audio equipment.

2. Description of the Related Art

With the continuous progress of technologies, electronic products are made as thin and light as possible, thus the user can carry the portable electronic products such as mini radio and walkman anytime and anywhere. In addition, the personal digital products such as MP3 players, mobile phones, Personal Digital Assistants (PDA) or laptop (notebook) computers have become indispensable in our daily life. Moreover, the mobile phone equipped with radio and MP3 player has also been introduced in market.

For the electronic products mentioned above, in order for the users to listen to the audio information in the electronic product without disturbing others, a headset has become a mandatory accessory for the electronic products. In addition, the headset provides better transmission of the sounds, such that the user can clearly listen to and understand the audio information, unlike the unclear voice transmitted through the air. Further, the audio information remains stable even when the user is in a motion state, such as exercising, driving, or in a noisy environment.

With regard to mobile phones, in order to reduce the possible harm from the EMW (Electro Magnetic Wave) in the human body, and to provide direct access to the mobile phone when the user's hands are tight, a bluetooth headset has been developed in recent years. The bluetooth headset applies a so-called “bluetooth” radio specification, where signals can be transmitted directionlessly, voice and written data can both be processed, multiple devices can be connected simultaneously, signal transmission angle is not limited and signals can pass through walls. Also, a bluetooth device is power-saving and user-friendly and has become a primary choice for wireless headset of the mobile phones.

However, most of the bluetooth headsets available in market can only be used in receiving the phone calls, thus when wearing the bluetooth headset, the user cannot listen to music, radio, or other audio information simultaneously, which is inconvenient. Of course, some high-end mobile phones also provide MP3 playing and FM radio functions, and the audio signal can be transmitted to the bluetooth headset. However, the manufacture cost of such phone-headset, where stereo audio signals are transmitted from a mobile phone with bluetooth specification to the bluetooth headset, is very high, because a stereo bluetooth transceiver is required for both the mobile phone and the bluetooth headset. Therefore, the cost is much higher than the general mono bluetooth transceiver used in the general bluetooth headset which can only receive the phone voice.

Furthermore, the selection of the MP3 soundtracks provided by the mobile phone is rather limited. If the user wishes to reset the soundtracks, watch video clips, or use other audio equipment, the bluetooth headset has to be replaced by the stereo headset for the audio equipment. As a result, when the stereo headset is receiving the audio signal provided by the audio equipment, the user may not be alerted by the ringing of the incoming calls. Accordingly, the bluetooth headset available in the market does not allow the user to enjoy the audio soundtracks provided by other audio equipment while waiting for the incoming call.

### SUMMARY OF THE INVENTION

Therefore, one object of the present invention is to provide a bluetooth device connectable to audio equipments. The bluetooth device is capable of transceiving audio signals from a mobile communication device and other audio equipment simultaneously, and transmitting the audio signals to a stereo headset connected to the bluetooth device.

Another object of the present invention is to provide a bluetooth headset connectable to audio equipments. The bluetooth headset is capable of transceiving audio signals from a mobile communication device and other audio equipment simultaneously.

The present invention provides a bluetooth device connectable to audio equipment. The bluetooth device is suitable for connecting a stereo headset, and for transceiving signals in a mobile communication device and an audio equipment. Wherein, the mobile communication device comprises a first bluetooth transceiver, and the audio equipment comprises a first audio-out port.

The bluetooth device is mainly composed of a second audio-out port, a second bluetooth transceiver, and an audio-in port. The second audio-out port is used to connect a stereo headset. The second bluetooth transceiver is connected to the second audio-out port for communicating with the first bluetooth transceiver to transceive signals from the mobile communication device. The audio-in port is connected to the second audio-out port and the audio-in port is used for connecting the first audio-out port of the audio equipment.

Wherein, after a calling signal from the mobile communication device has been received by the second bluetooth transceiver, the audio signal transmitted to the stereo headset is switched to the audio signal provided by the mobile communication device.

In the bluetooth device connectable to audio equipment mentioned above, the audio-in port is, for example, connected to the first audio-out port of the audio equipment via a connection cable. In addition, the bluetooth device mentioned above, for example, further comprises a microphone and a speaker, and both the microphone and the speaker are connected to the second bluetooth transceiver.

Moreover, the bluetooth device mentioned above further comprises a battery for supplying power to bluetooth device. The audio equipment may be a MP3 player, a CD player, a TV, a radio, a VCD player, a DVD player, a laptop computer, a Personal Digital Assistant (PDA), a car stereo, or a home stereo system.

The present invention provides a bluetooth headset connectable to audio equipment. The bluetooth headset is suitable for transceiving signals in a mobile communication device and an audio equipment. Wherein, the mobile communication device comprises a first bluetooth transceiver, and the bluetooth headset is connected to an audio-in port of the audio equipment via a connection cable.

The bluetooth headset mainly comprises a first unit, a microphone, and a second unit. The first unit comprises a first speaker, a second bluetooth transceiver, and an audio-in port. The first speaker is connected to both the second bluetooth transceiver and the audio-in port. The second bluetooth transceiver communicates with the first bluetooth transceiver to transceive signals in the mobile communication device. The audio-in port is used for connecting the connection cable mentioned above. The microphone is connected to the second bluetooth transceiver. The second unit comprises a second speaker, which is connected to both the second bluetooth transceiver and the audio-in port.

Wherein, after a calling signal from the mobile communication device is received by the second bluetooth transceiver, at least one of the audio signals transmitted to the first speaker and the second speaker is switched to the audio signal provided by the mobile communication device.

In the bluetooth headset connectable to audio equipment mentioned above, the second unit, for example, further comprises a battery for supplying power to the bluetooth earphone. Alternatively, the power to the bluetooth headset can be supplied by the audio equipment via the connection cable. In addition, the audio equipment may be a MP3 player, a CD player, a TV, a radio, a VCD player, a DVD player, a laptop computer, a Personal Digital Assistant (PDA), a car stereo, or a home stereo system.

In summary, with the bluetooth headset and the bluetooth device connectable to audio equipment in the present invention, the user can enjoy the audio information provided by MP3 or radio in the externally connected audio equipment while waiting for the incoming call without too much cost. Therefore, any important call will not be missed.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a connection diagram of a bluetooth device and a stereo headset, a mobile communication device, and an audio equipment according to a first embodiment of the present invention.

FIG. 2 schematically shows a block diagram of FIG. 1.

FIG. 3 schematically shows a connection diagram of a bluetooth device and a stereo headset, a mobile communication device, and an audio equipment according to a second embodiment of the present invention.

FIG. 4 schematically shows a block diagram of FIG. 3.

FIG. 5 schematically shows a connection diagram of a bluetooth headset, a mobile communication device, and an audio equipment according to a third embodiment of the present invention.

FIG. 6 schematically shows a block diagram of FIG. 5.

### DESCRIPTION OF THE EMBODIMENTS

### First Embodiment

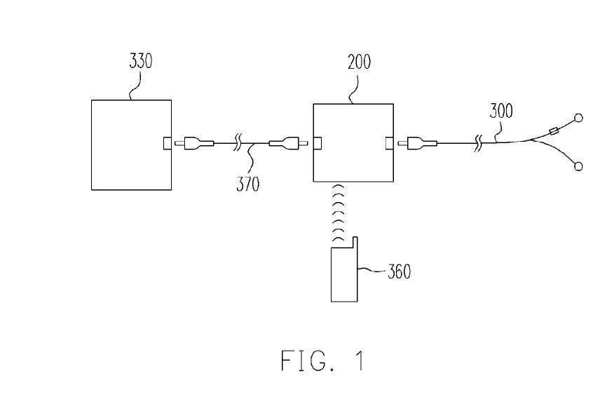

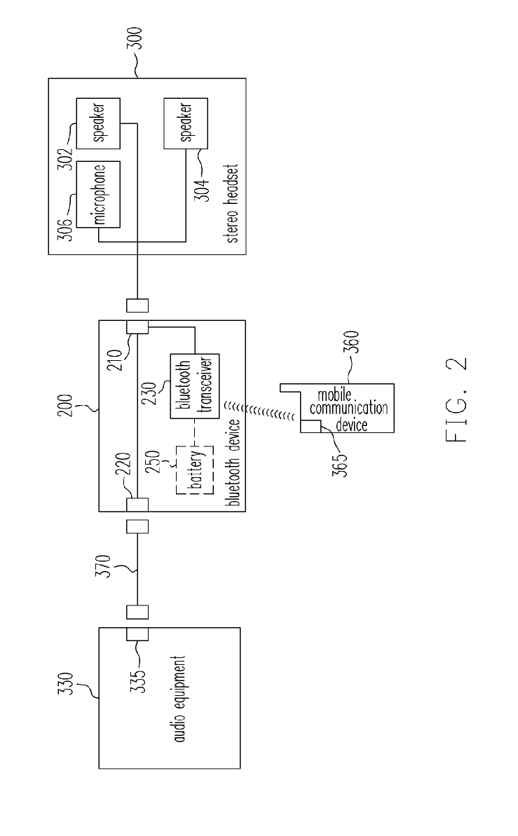

FIG. 1 schematically shows a connection diagram of a bluetooth device and a stereo headset, a mobile communication device, and an audio equipment according to a first embodiment of the present invention. FIG. 2 schematically shows a block diagram of FIG. 1.

Referring to both FIG. 1 and FIG. 2, when using the bluetooth device 200 connectable to audio equipment of the present embodiment, a stereo headset 300 and an audio equipment 330 are both connected to it, and the bluetooth device 200 communicates with a mobile communication device 360 wirelessly with bluetooth technology. Wherein, a bluetooth transceiver 365 is embedded in the mobile communication device 360, and the audio equipment 330 has an audio-out port 335. The mobile communication device 360 may be a general mobile phone or a smart mobile phone where various functions such as MP3 player, PDA, cameras, video players are integrated. The audio equipment 330 may be a MP3 player, a CD player, a TV, a radio, a VCD player, a DVD player, a laptop computer, a Personal Digital Assistant (PDA), a car stereo, or a home stereo system. The audio-out port 335 of the audio equipment 330 may be a female jack or other connectors. The stereo headset 300, for example, comprises two speakers 302, 304, and a microphone 306.

An audio-out port 210, an audio-in port 220, and a bluetooth transceiver 230 are configured inside the bluetooth device 200. Wherein, the bluetooth transceiver 230 is connected to the audio-out port 210. The bluetooth transceiver 230 with the bluetooth specification communicates with a bluetooth transceiver 356 of the mobile communication device 360 for transceiving signals from the mobile communication device 360 (wherein the signals may be, for example, music, audio, text, or other information). The audio-in port 220 is connected to the audio-out port 335 of the audio equipment 330 via, for example but not limited to, a connection cable 370, which may be a general audio signal cable. The audio-in port 220 and the bluetooth transceiver 230 are connected to the audio-out port 210, respectively. The stereo headset 300 may be connected to the audio-out port 210. Wherein, the audio-out port 210 and the audio-in port 220 may be female jacks or other connectors.

Under normal situation, the audio signals provided by the audio equipment 330 of the MP3 player are sequentially transmitted to the stereo headset 300 connected to the audio-out port 210 via the connection cable 370 and the bluetooth device 200, such that the bluetooth device 200 user can enjoy the music provided by the audio equipment 330. Meanwhile, the bluetooth transceiver 230 is in a standby mode. When calling signal from the mobile communication device 360 is received by the bluetooth transceiver 230, the bluetooth device 200 automatically switches the audio signal transmitted to the stereo headset 300 to the audio signal provided by the mobile communication device 360.

Although in the embodiment mentioned above, the bluetooth device 200 is connected to the audio equipment 330 via a plug-in connection cable 370, the connection cable 370 may also be fixed to the bluetooth device 200. In other words, the audio-in port 220 may be extended from the bluetooth device 200 via a fixed cable and can plug into the audio-out port 335 of the audio equipment 330. In addition, a battery 250 may be further configured in the bluetooth device 200 for supplying power to the bluetooth device 200.

### Second Embodiment

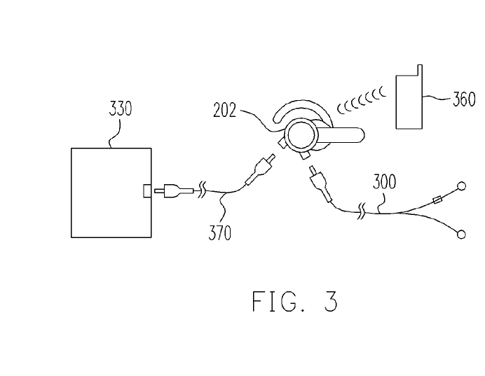

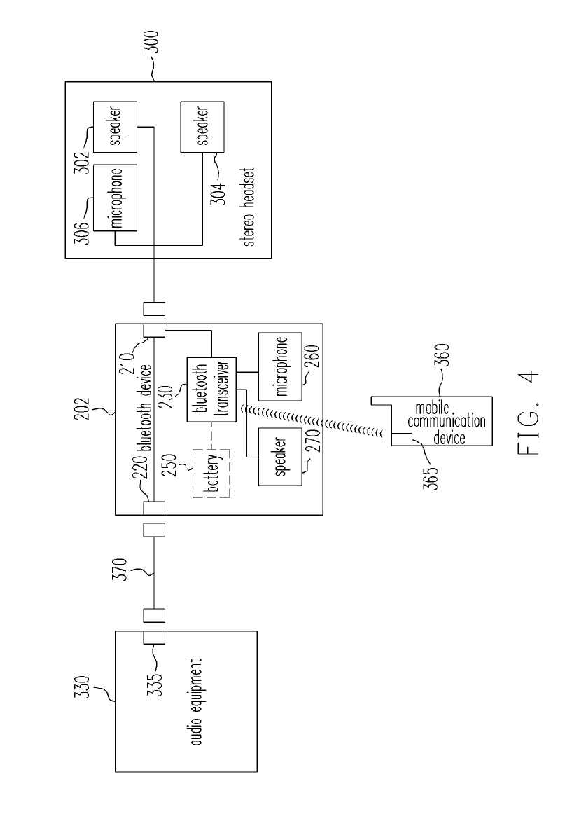

FIG. 3 schematically shows a connection diagram of a bluetooth device and a stereo headset, a mobile communication device, and an audio equipment according to a second embodiment of the present invention. FIG. 4 schematically shows a block diagram of FIG. 3.

Referring to both FIG. 3 and FIG. 4, the difference between the bluetooth device 202 of the present embodiment and the bluetooth device 200 of the first embodiment is that a microphone 260 and a speaker 270 are further configured in the bluetooth device 202 in the present embodiment, thus the details of other similar components are not repeated. Both the microphone 260 and the speaker 270 are connected to the bluetooth transceiver 230. Since the microphone 260 and the speaker 270 are added to the bluetooth device 202, in case both the stereo headset 300 and the audio equipment 330 are not connected to the bluetooth device 202, the user may wear the bluetooth device 202 as a bluetooth headset only for picking up incoming calls. In addition, the advantages of the first embodiment also remain in the bluetooth device 202; that is, the user can enjoy various audio information such as music or radio by connecting the audio equipment 330 and the stereo headset 300, and the bluetooth device 202 can automatically receive the incoming call once a calling signal is received by the mobile communication device 360, such that the user can use the stereo headset 300 to pick up the phone.

### Third Embodiment

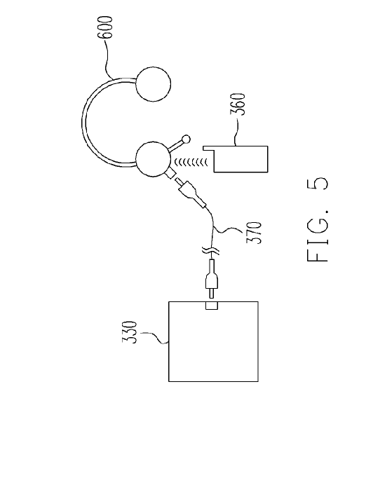

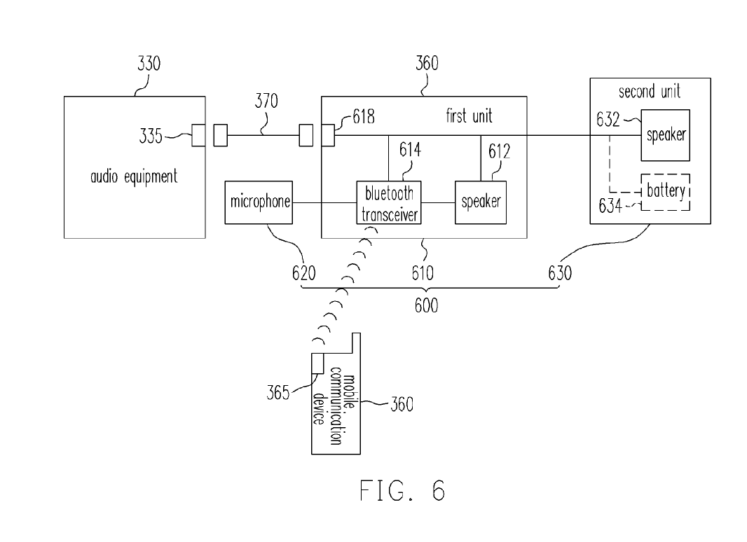

FIG. 5 schematically shows a connection diagram of a bluetooth stereo headset, a mobile communication device, and an audio equipment according to a third embodiment of the present invention. FIG. 6 schematically shows a block diagram of FIG. 5.

Referring to both FIG. 5 and FIG. 6, when using a bluetooth headset 600 connectable to audio equipment of the present embodiment, it is connected to the audio equipment 330 via the connection cable 370 mentioned above, and the bluetooth technology enables it to communicate with the mobile communication device 360 wirelessly. Wherein, the connection cable 370, the mobile communication device 360, and the audio equipment 330 are the same as those described in the previous embodiments.

The bluetooth headset 600 mainly comprises a first unit 610, a microphone 620, and a second unit 630. Wherein, a speaker 612, a bluetooth transceiver 614, and an audio-in port 618 are configured inside the first unit 610. The speaker 612 is connected to the bluetooth transceiver 614 and the audio-in port 618. The bluetooth transceiver 614 with the bluetooth specification communicates with a bluetooth transceiver 356 of the mobile communication device 360 for transceiving signals from the mobile communication device 360 (wherein the signals may be, for example, music, audio, text, or other information). The audio-in port 618 is connected to the audio-out port 335 of the audio equipment 330 via the connection cable 370. The microphone 620 is connected to the bluetooth transceiver 614. A speaker 632, which is connected to both the bluetooth transceiver 614 and the audio-in port 618, is configured inside the second unit 630.

Similar to the previous embodiments, the bluetooth headset 600 is connected to the audio equipment 330 such as MP3 players via the connection cable 370, and the audio signal provided by the audio equipment 330 is transmitted to the speakers 612, 632 of the bluetooth headset 600 via the connection cable 370, such that the user can enjoy the music provided by the audio equipment 330. Meanwhile, the bluetooth transceiver 616 is in a standby mode. When a calling signal from the mobile communication device 360 is received by the bluetooth transceiver 616, the bluetooth headset 600 automatically switches the audio signal transmitted to the speakers 612, 632 to the audio signal provided by the mobile communication device 360.

Inside the bluetooth headset 600, a battery 634 may be configured in the second unit 630 for supplying power to the bluetooth headset 600.

It is to be noted that the spirit of the present invention is to use a single host to transceive the stereo audio signals through the bluetooth specification of the mobile communication device and other audio equipment. Accordingly, the user can enjoy the music provided by the audio equipment via the stereo headset, and pick up the phone calls in time via the wireless communication between the bluetooth transceiver and the mobile communication cable.

In summary, in the bluetooth headset and the bluetooth device connectable to audio equipment in the present invention, through the automatic switch function of the signals provided by the bluetooth headset and the bluetooth device, the bluetooth mobile phone user can enjoy the audio information such as MP3 music, radio provided by other externally connected audio equipment while waiting for the incoming calls, such that important calls will not be missed.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A bluetooth device connectable to audio equipment, suitable for connecting a stereo headset and suitable for transceiving signal in a mobile communication device and an audio equipment, wherein the mobile communication device comprises a first bluetooth transceiver, the audio equipment comprises a first audio-out port, and the bluetooth device comprises:
a second audio-out port for connecting the stereo headset;
a second bluetooth transceiver connected to the second audio-out port for communicating with the first bluetooth transceiver to transceive signal provided by the mobile communication device; and
an audio-in port connected to the second audio-out port for connecting to the first audio-out port of the audio equipment,
wherein when a calling signal from the mobile communication device is received by the second bluetooth transceiver, the audio signal transmitted to the stereo headset is switched to the audio signal provided by the mobile communication device.

2. The bluetooth device connectable to audio equipment of claim 1, wherein the audio-in port is connected to the first audio-out port of the audio equipment via a connection cable.

3. The bluetooth device connectable to audio equipment of claim 2, further comprising:
a microphone connected to the second bluetooth transceiver; and
a speaker connected to the second bluetooth transceiver.

4. The bluetooth device connectable to audio equipment of claim 1, further comprising a battery for supplying power to the bluetooth device.

5. The bluetooth device connectable to audio equipment of claim 1, wherein the audio equipment comprises a MP3 player, a CD player, a TV, a radio, a VCD player, a DVD player, a laptop computer, a Personal Digital Assistant (PDA), a car stereo, or a home stereo system.

6. A bluetooth headset connectable to audio equipment, suitable for transceiving signal in a mobile communication device and an audio equipment, wherein the mobile communication device comprises a first bluetooth transceiver, and the bluetooth headset is connected to an audio-out port of the audio equipment via a connection cable, and the bluetooth headset comprises:
a first unit comprising a first speaker, a second bluetooth transceiver, and an audio-in port, wherein the first speaker is connected to the second bluetooth transceiver and the audio-in port, the second bluetooth transceiver communicates with the first bluetooth transceiver for transceiving signal from the mobile communication device, and the audio-in port is for connecting the connection cable;
a microphone connected to the second bluetooth transceiver; and
a second unit comprising a second speaker, which is connected to the second bluetooth transceiver and the audio-in port,
wherein when a calling signal from the mobile communication device is received by the second bluetooth transceiver, at least one of the audio signals transmitted to the first speaker and the second speaker is switched to the audio signal provided by the mobile communication device.

7. The bluetooth headset connectable to audio equipment of claim 6, wherein a battery is further configured in the second unit for supplying power to the bluetooth headset.

8. The bluetooth headset connectable to audio equipment of claim 6, wherein the audio equipment comprises a MP3 player, a CD player, a TV, a radio, a VCD player, a DVD player, a laptop computer, a Personal Digital Assistant (PDA), a car stereo, or a home stereo system.
